(19) United States
(12) Patent Application Publication
(10) Pub. No.: US 2001/0037273 A1
(43) Pub. Date: Nov. 1, 2001

(54) Commercial real estate lease automation system

(76) Inventor: George Richard Greenlee JR., Dallas, TX (US)

Correspondence Address: William A. Munck, Esq., Novakov Davis & Munck, P.C., 900 Three Galleria Tower, 13155 Noel Road, Dallas, TX, 75240, US

(21) Appl. No.: 09/798,471

(22) Filed: Mar. 2, 2001

Related U.S. Application Data
(60) Provisional application No. 60/186,447, filed on Mar. 2, 2000.

(51) Int. Cl. G06F 17/60

(52) U.S. Cl. 705/35

(57) ABSTRACT

A property leasing system comprises individual modules, including a transaction management application and a property database for storing data supplied by property providers and property users. A real-time interface is provided between the property leasing system database and a property provider's in-house property management system to extract real time, time sensitive, targeted data available from the provider's in-house property management system. The transaction management application is coupled with the interfaces to the in-house property management systems and the property database to utilize and update data stored in the database and the in-house property management system to automate a leasing cycle between a property provider and a property user.

### CROSS REFERENCE TO RELATED APPLICATIONS

The present invention is related to that disclosed in U.S. Provisional Patent Application No. 60/186,447 entitled Commercial Real Estate Lease Automation System filed Mar. 2, 2000 (the specification of the present invention claims priority to this provisional application under 35 U.S.C. '119(e)(1)). The provisional patent application and the inventions disclosed therein are incorporated herein by reference for all purposes as if fully set forth herein.

### TECHNICAL FIELD OF THE INVENTION

The present invention is directed, in general, to property leasing systems and, more specifically, to a system for automating the leasing of commercial real estate.

### BACKGROUND OF THE INVENTION

The commercial real estate leasing industry has existed for a number of years with a highly inefficient and costly business model based on imperfect market information. The fragmentation of this market information, as well as the existence of the traditional and inefficient business transaction model, results in the commercial real estate industry maintaining an unnecessarily long transaction cycle and a severely inflated cost structure.

The commercial real estate leasing industry lacks not only complete, accurate, and real-time information on lease space availability and but also an industry-wide standardized transaction processes. This creates the inefficient market with both long transaction cycles and inflated leasing costs to all parties involved in the process. Because real-time, standardized and accurate market information is not readily available, the cost to all participants associated with commercial real estate lease transactions is extremely high. These costs include the extremely large fees that commercial real estate brokers receive for brokering commercial lease transactions. Acting as the “middleman,” or intermediary, brokers focus mainly on market research and lease business point negotiation and act as information and documentation managers.

From conception to move-in, today's typical commercial real estate lease transaction begins with a tenant having a need for space and takes anywhere from nine to twenty four months to complete. A tenant or tenant's broker spends about forty percent (40%) of that time in collecting, managing, and analyzing lease availability information (market research). Additionally, commercial real estate professionals spend an estimated forty to fifty percent (40-50%) of their time authoring, editing, and collaborating on numerous versions of non-standardized paper documents during each transaction. Only the remaining ten to twenty percent (10-20%) of a broker's time is actually spent on the value added services of negotiating the lease transaction.

Moreover, the average period of vacancy for commercial real estate office space ranges from six to eight months. This is due to extremely inefficient turns in property owners inventory (space for lease). Because real-time and forward-looking information on leased-space market alternatives is virtually non-existent, a long transaction cycle is created that makes turn-in vacant inventory slow and extremely costly for landlords. Each day that office space remains vacant represents lost rental revenue that can never be recaptured by a landlord.

The large amount of inefficiency built into conventional commercial lease engagement results in a costly and time-consuming negotiation process for all parties involved in commercial real estate lease transactions. Such parties include tenants, brokers, landlords, leasing agents, asset managers, and all other related parties. This inefficient process creates an inefficient marketplace, resulting in substantial overall transaction costs associated with leasing office space, as recognized by both sides (landlords and tenants) of the market. These transactions costs are borne ultimately by tenants as well as landlords, as such costs are built into the lease rental rate.

Conventionally, there are a number of traditional third-party research services that gather and disseminate commercial lease space availability and listing information exclusively to the brokerage community. These firms continue to use outdated and inefficient research procedures to collect market information on the availability of commercial lease office space. These firms use a business model based on a revenue stream and exclusive support from the commercial real estate brokerage community. These firms continue to reiterate that they rely exclusively on the brokerage community for access to market information and financial prosperity and do not intend to make their services available to any entity outside the brokerage community. Moreover, while this information is, by conventional standards, the best available in the market, the information that traditional firms provide is only sixty (60) to seventy percent (70%) accurate at best.

There are also several new companies with new Internet-based listing models. These companies have attempted to use the Internet to collect and provide information for the commercial real estate industry. While these firms are beginning to educate the market as to the efficiencies that the Internet and technology can bring to the commercial real estate industry, they continue to cater to the traditional business model without reducing costs, standardizing information, streamlining leasing transaction processes or focusing on customer-centric transaction-based solutions.

Further, while these listing services have begun to improve the centralization of market information through economies of scale, they continue to use outdated and inefficient manual collection procedures, and lack the checks and balances needed to guarantee accuracy and completeness of the information. These current Internet-based services are highly incomplete with respect to the data collected, lack practical market coverage, and are virtually useless for actually finding accurate alternatives for leasing commercial property where complete, accurate information is required. They also fail to manage the lengthy transaction of securing space that follows if and when a “match” is made.

In sum, no entity, system, or database exists today that either houses or makes available real-time, accurate information on commercial real estate property market. Nor does there exist any system that manages, standardizes, or centralizes the entire, two-sided commercial leasing transaction process.

In the multi-billion dollar commercial real estate leasing industry, thousands of tenant brokerage firms, individual tenants, corporations, small companies, property-leasing agents, and landlords desire real-time, accurate information on the availability of commercial real estate space. Yet, conventional systems fail to provide real-time, accurate information on the availability of commercial real estate space.

Referring to FIG. 7 of the drawings, the reference numbers 706, 708 and 710 generally designate providers of commercial real estate office space embodying features of the prior art. The system 700 includes a user 702 that is a future tenant and a user broker 704 representing the user 702 in leasing office space in a commercial building from a provider such as providers 706, 708 and 710, three of which are shown in FIG. 7, though more or less than three providers may be considered. Typically, broker 704 interacts with leasing agents 711, 712 and 713, who are responsible for lease transactions for respective providers 706, 708 and 710. Initially, broker 704 will consult user 702 to obtain information on his or her needs with regard to space, location, price, and the like.

After obtaining the needs from user 702, broker 704 searches third party market research database 718, such as CoStar™ a well known market research firm, for information relating to available office space, such as quantity of space, location and the like, to identify lease space that meets the needs of the future tenant, user 702. In accordance with the prior art, market research from the third party market research database 718 is not directly accessible by user 702 or broker 704. Instead, information contained in database 718 is provided to broker 704 at predetermined periodic intervals, e.g., monthly, and is, therefore, not synchronized with database 718 in real time.

Not only is the information in database 718 not synchronized in real time, the information-gathering process used to update database 718 also does not reflect comprehensive, real-time lease availability information of the market, either. This is because database 718 is not automatically updated in real time, but manually updated by research team 722, which contacts leasing agents 711, 712 and 713 at periodic intervals. Therefore, database 718 can only serve as a starting point for obtaining information on the office space market. Additionally, broker 704 usually employs research analyst 720 to analyze the accumulated information available from market research database 718. Market analyst 720 would contact either agents 711, 712 and 713 or providers 706, 708 and 710 to verify every piece of information provided by market research 718 in order to provide opinions on available properties based on the requirements presented by user 702. Broker 704 presents the accumulated information to user 702. User 702 decides on properties to seriously consider and broker 704 contacts provider agents 711, 712 or 713 or providers 706, 708, 710 to schedule physical inspection of the properties and to further begin negotiations for a lease on the property.

Therefore, there exists a need for an improved leasing transaction system having a centralized database containing real-time, accurate, comprehensive and time sensitive information on lease space availability of commercial real estate.

### SUMMARY OF THE INVENTION

To address the above-discussed deficiencies of the prior art, it is a primary object of the present invention to provide, for use in a network, a complete, two-sided property leasing system for automating all leasing procedures. The property leasing system comprises individual modules, including a transaction management application and databases for storing data supplied by property lessors/owners (sometimes hereinafter “providers”) and property lessees (sometimes hereinafter “users”). A real-time electronic interface is provided between the property database and a property provider's in-house property management system to extract targeted data that is available from the provider's in-house property management and leasing system(s). A computer program is coupled to the interfaces and the database(s) to utilize and update data stored in the database(s) and in the in-house property management system to automate a leasing cycle between a property provider and a property user.

In an alternate embodiment of the present invention, the computer program is capable of providing all processes involved in a leasing transaction that are necessary for initiating, negotiating and completing a lease document for signature, all within a complete leasing cycle.

In another embodiment of the present invention, the database contains data supplied by a provider that comprises physical details of each available property and leasable units therein, photographic and video images of the property on a space-by-space basis, demographic data and traffic data of the neighborhood surrounding the property and leasing terms for the property.

In yet another embodiment of the present invention, the interface comprises a computer application for extracting the contents of targeted fields in the provider's in-house property management system and, when so commanded, is capable of sending selected data to the property leasing system database(s) via the network.

In still another embodiment of the present invention, the property leasing system comprises additional modules wherein one module generates all necessary documents to initiate, negotiate and complete a leasing cycle from the initial interest of the user to the final document generation for consummating the lease transaction.

In another embodiment of the present invention, the interface is capable of listing, leasing and/or managing spaces within the provider's properties for the individual property management systems.

In another embodiment of the present invention, the interface comprises a computer application for automatically updating the contents of targeted fields in the provider's in-house property management system after a lease transaction is complete.

In yet another embodiment of the present invention, the property leasing system further comprises a module for determining whether a selected space will fit the parameters of the user.

In still another embodiment of the present invention, the property leasing system further comprises a module for generating all correspondence necessary to initiate, negotiate and complete a lease cycle.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a high-level block diagram of exemplary automated property leasing system 100 according to an embodiment of the present invention;

FIG. 2 illustrates a high-level block diagram of exemplary automated property leasing system 200 according to an embodiment of the present invention;

FIG. 3 illustrates a high-level block diagram of exemplary automated property leasing system 300 according to an embodiment of the present invention;

FIGS. 4A-4C illustrate a high-level flow diagram of a method for automating property leasing procedures according to an embodiment of the present invention;

FIG. 5 illustrates a high-level block diagram of interface 500 according to an embodiment of the present invention;

FIG. 6 is a high-level flow diagram of a method for automating property leasing procedures for providers according to an embodiment of the present invention; and

FIG. 7 depicts a high-level block diagram of a prior art real estate leasing model.

### DETAILED DESCRIPTION OF THE INVENTION

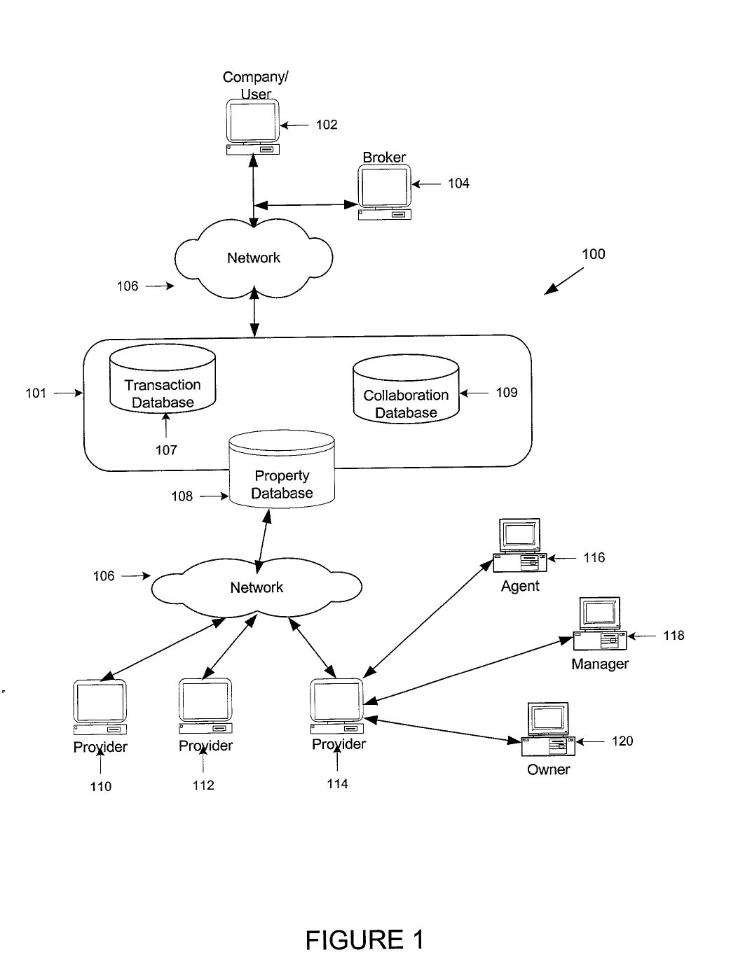

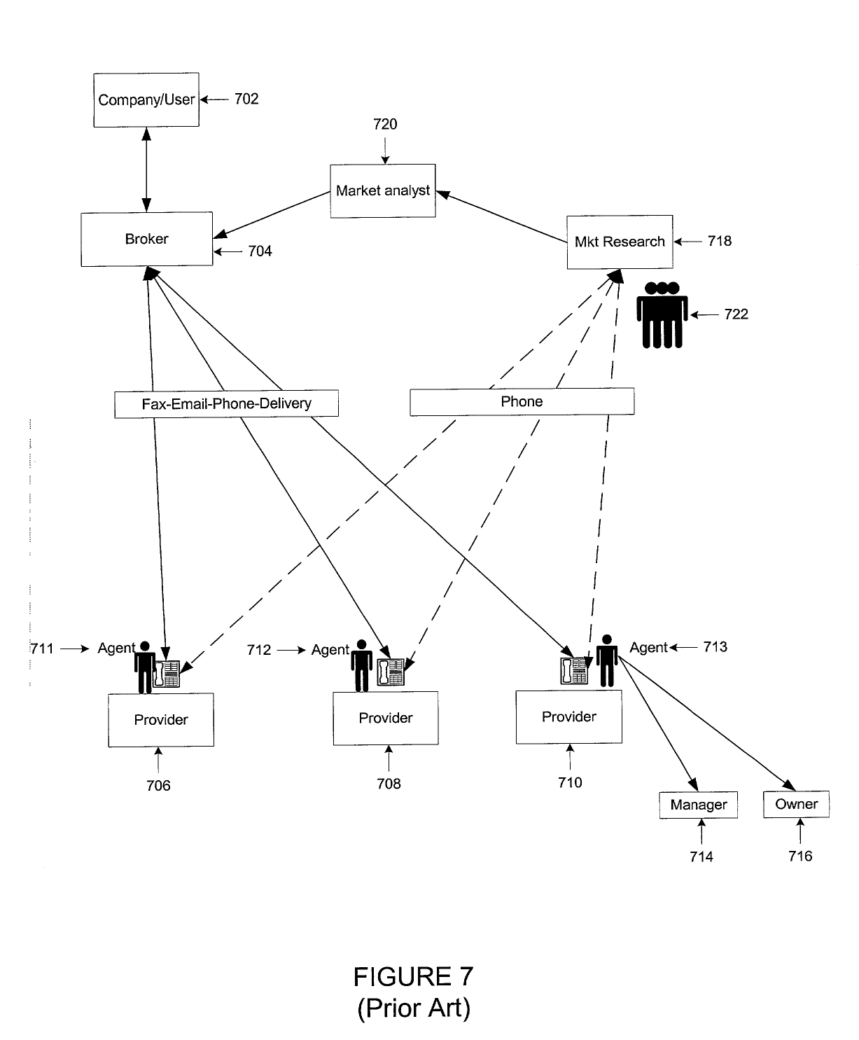

FIGS. 1 through 7, and the various embodiments used to describe the principles of the present invention in this patent document are by way of illustration only and should not be construed in any way to limit the scope of the invention. Even though this embodiment is directed towards leasing commercial office space, those skilled in the art will understand that the principles of the present invention may be implemented in any suitably arranged automated property leasing system.

FIG. 1 illustrates a high-level block diagram of an exemplary, automated leasing system 100 according to an embodiment of the present invention. Company/user (“user”) 102 is a prospective tenant that is beginning the process of leasing a leasable unit within a commercial real estate property. Broker 104 is an independent real estate broker that is a subscriber to automated property leasing system 100. Both user 102 and broker 104 are connected to transaction management application 101 via network 106. Network 106 may be the Internet, a private network, a dial up system, or any system that will permit multiple computer systems to be connected to transaction management application 101. Transaction management application 101 receives and stores data, via network 106, from provider 110, provider 112 and provider 114, from broker 104 and user 102 and the other parties involved in a lease transaction.

The automated property leasing system comprises a computer system coupled to and operating transaction management application 101, transaction management database 107, property database 108 and collaboration database 109. Transaction management application 101 is a computer operable program that manages property database 108. Property database 108 contains real-time and time sensitive information on multiple aspects of individual, leasable spaces in properties (buildings) that are owned or managed by providers 110, 112, and 114. The pertinent information stored in property database 108 includes space size, space location, space condition, availability and the like.

Transaction database 107 is used in the automatic property leasing system for storing and providing transactions that occur between user 102, broker 104 and providers 110, 112 and 114. The transactions may include RFPs, negotiations, lease proposals and formal lease documents as well as general information about the user, broker or transaction detail data. Collaboration database 109 contains all the communications between the parties including Emails, copies of electronically generated letters, informal negotiation proposals and the like. Collaboration database 109 is also used for online collaboration of lease documents. This includes document storage, document tracking, versioning, redlining, accepting and so on.

Providers generally have personnel, such as leasing agent 116 and property manager 118, that that perform various business functions for the provider such as leasing or managing property.

The agents' responsibilities include disseminating information to brokers and users about space available for lease from the providers. Much of the data needed to assimilate such information is available within so-called “property management systems.” These property management systems (not shown) are usually commercial software packages operating on computers that are variations on financial systems that are used by providers to keep track of property billing, property worth, return on investment, lease terms, etc. What the property management systems do not do is utilize all the data that is available within the respective property management system databases for use in leasing space or managing space inventory. Nor do these property management systems help manage lease transactions.

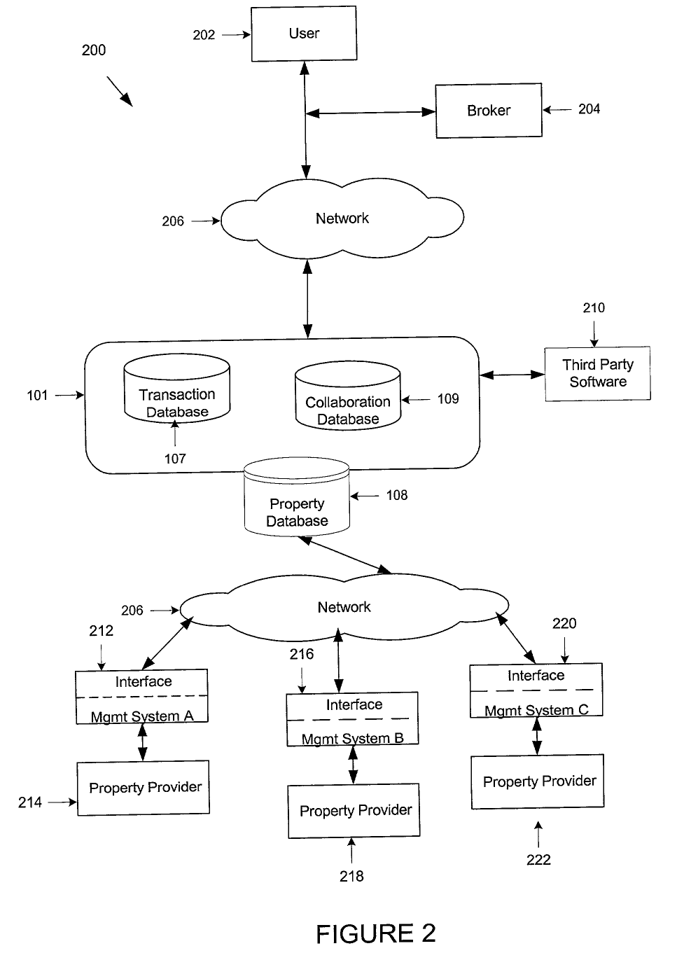

FIG. 2 illustrates a high-level block diagram of exemplary automated property leasing system 200 according to one embodiment of the present invention. Automated property leasing system 200 comprises prospective tenant (user) 202, user broker 204, transaction management application 101, property providers 214, 218 and 222, and network 206 connecting property providers 214, 218 and 222 with the user 202 and broker 204. Network 206 may be the Internet, wide area network, dial-up modem network, VPN or the like. User 202, in this embodiment, is searching for office space and may or may not currently be a tenant of any of real estate (property) owned by providers 214, 218 and 222. Generally, broker 204 is a subscribing member to transaction management application 101 and works directly with user 202. User 202 may make inquiries and work through broker 204 or may directly access transaction management application 101 (hereinafter “LeaseBoard™” 101) without the assistance of a broker 204. User 202 may be a corporate entity that has its own in-house real estate department with little need for a broker's services and is able to directly access LeaseBoard™ 101.

User 202 and broker 204 may access LeaseBoard™ 101 through network 206 (or through a private network) or the like. Network 206 passes the communications to LeaseBoard™ 101, which controls all the inputs and outputs to system databases 107, 108 and 109. Transaction management application 101 and system databases 107, 108 and 109 are coupled with software tools and contain all the information necessary to initiate, negotiate and complete an office space leasing cycle in property leasing system 200. That cycle includes user 202 (or prospective user 202) determining that a need for office space exists, doing (or having done) the research necessary to make an informed decision on which properties to consider, sending a request for proposal to the provider of the property, reviewing proposals from the providers, producing counteroffers (negotiating), agreeing to a price, and completing the deal by executing lease documents with the property provider.

LeaseBoard™ 101 may utilize commercially available special purpose software 210 to provide boilerplate legal documents, letters, proposals, etc., for the participants (user, broker, provider) during and after the leasing procedure.

In this embodiment of the present invention, property providers 214, 218 and 222 are connected to LeaseBoard™ 101 via network 206. Provider 214, provider 218 and provider 222 may each utilize a proprietary property management system, a commercial property management system such as CTI™ (a product of CTI, Limited, Inc., Dallas, Tex.), MRI™ (a product of Management Reports International, Cleveland, Ohio), a similar leasing application or the like. Regardless of which system a provider may use, if any, interface 212, interface 216, and interface 220 are provided to connect with each aforementioned in-house property management system to communicate via network 206 with LeaseBoard™ 101 and the system databases 107, 108 and 109. Interfaces 212, 216 and 220 are operable to retrieve targeted data within the provider's property management systems and provide that data to LeaseBoard™ 101, property database 108 and the providers 214, 218 and 222. Data may also be provided to the LeaseBoard™ 101 and property database 108 by collecting pertinent data about a property and sending a hard copy for entry into property database 108. Further, the data may be entered into an electronic form and sent to LeaseBoard™ 101 for inclusion in property database 108.

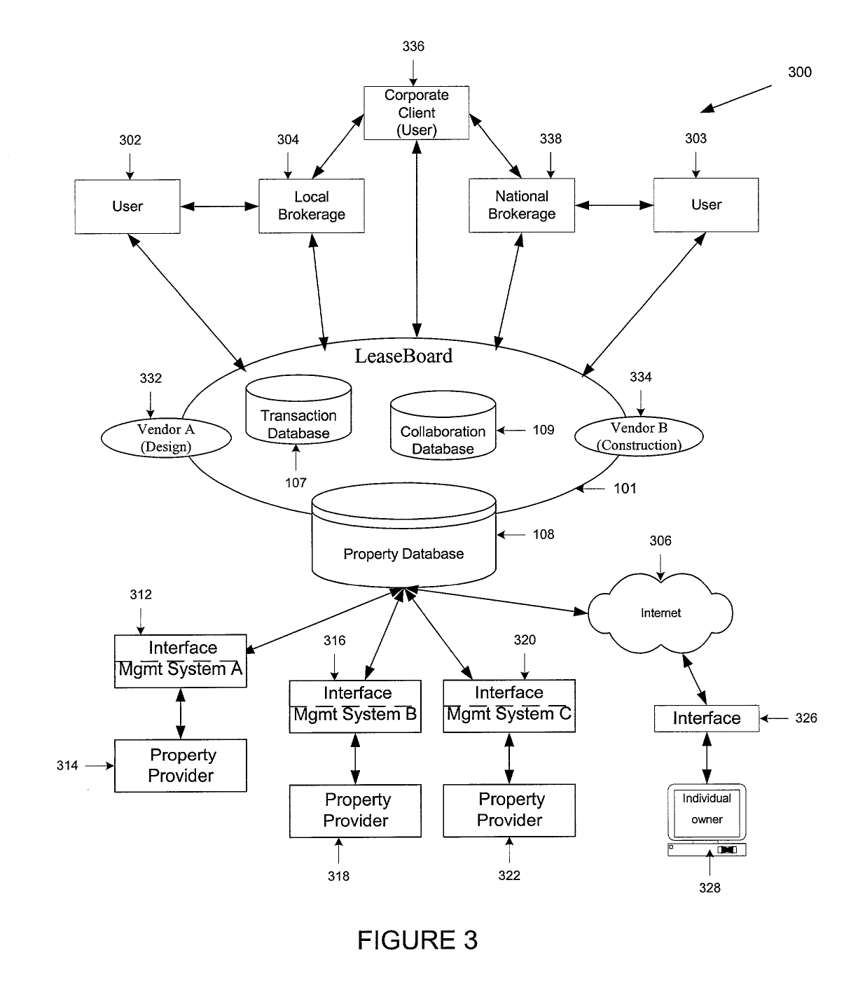

FIG. 3 illustrates a high-level block diagram of automated property leasing system 300 according to an embodiment of the present invention. A network (details not shown) is provided where communication with LeaseBoard™ 101 is generally accomplished via the Internet, private network, VPN, modem, telephone line communication or the like. Property providers 314, 318 and 322 have individual property management software package interfaces 312, 316, and 320 for automatic communication and data exchange with LeaseBoard™ 101 and property database 108. Individual owner interface 326, connects owner 328 to the network via Internet or a direct link 306 utilizing software provided by LeaseBoard™. All the property providers (314, 318, 322) are supplied with interfaces (312, 316, 320) to the providers' in-house property management system that facilitates transfer of property information from the in-house system to LeaseBoard™ 101's property database 108.

Interfaces 312, 316, 320 and 326 include software and hardware that are capable of querying the in-house software of the connected provider for specific information concerning properties under management. Each interface provides a display of the provider's properties and/or the leasable units within that fit a set of business rules initially set up by each provider. The business rules are a set of criteria that determine the properties and leasable units within that the provider wants to make available for lease on LeaseBoard™ 101 and property database 108. The business rule criteria may include space, location, number of floors, timing, whether or not the space is empty, the fact that the current lease is set to expire in a certain period, etc.

After a user reviews selections from property database 108, a “request for proposal” (RFP) may be presented by LeaseBoard™ 101 to the selected providers. The RFP is organized from data available in the system databases 107 and 109, and generated by LeaseBoard™ 101 on behalf of a user (e.g., user 302) and stored in a secure portion of transaction database 107. The provider is notified of the RFP and the provider has the option to respond to said RFP.

LeaseBoard™ 101 may be comprised of multiple software modules and/or hardware implemented/embedded programs that operate and interact with system databases 107, 108 and 109. Vendor A (design) module 332 is a software program integrated into LeaseBoard™ 101 that may be utilized by a user (user 302, user 303 or corporate client 336) or professional design partners to assist in the design of the layout for a prospective office space. Vendor B (construction) module 334 is an integrated program that may be utilized by user 302, 303 or 336 or professional construction partners to specify, negotiate and complete an office space construction contract with a contractor for a newly leased space.

Users of office lease space include individual user 302, individual user 303 and corporate client 336. Both types of clients may be represented by local real estate broker 304 or national real estate broker 338. Also, both types of clients may represent themselves directly with LeaseBoard™ 101 by connecting through LeaseBoard™ 101 instead of connecting through the broker 304 or broker 338.

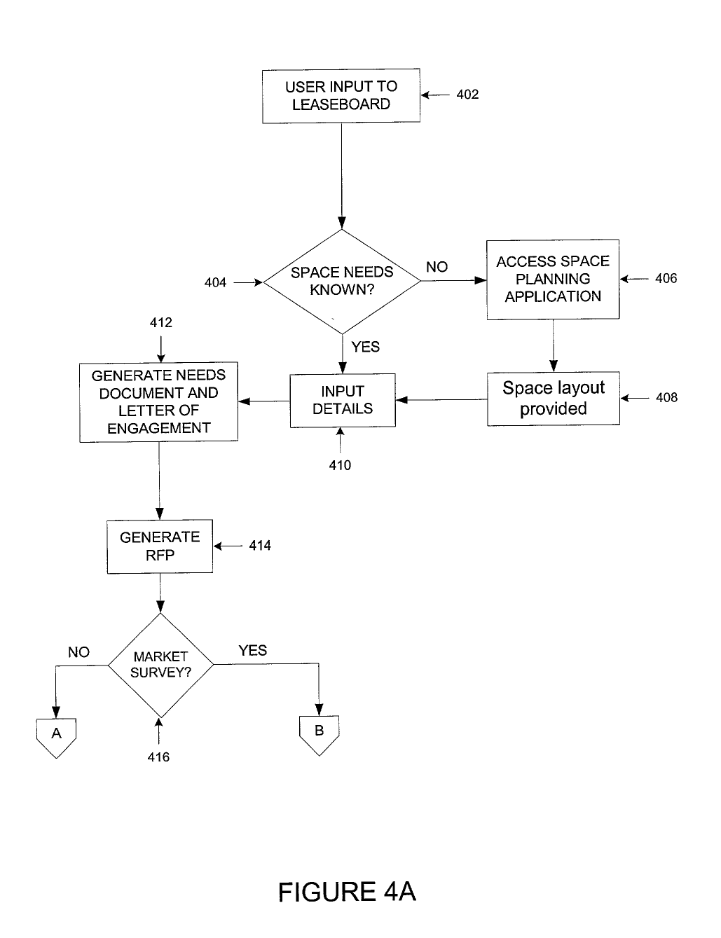

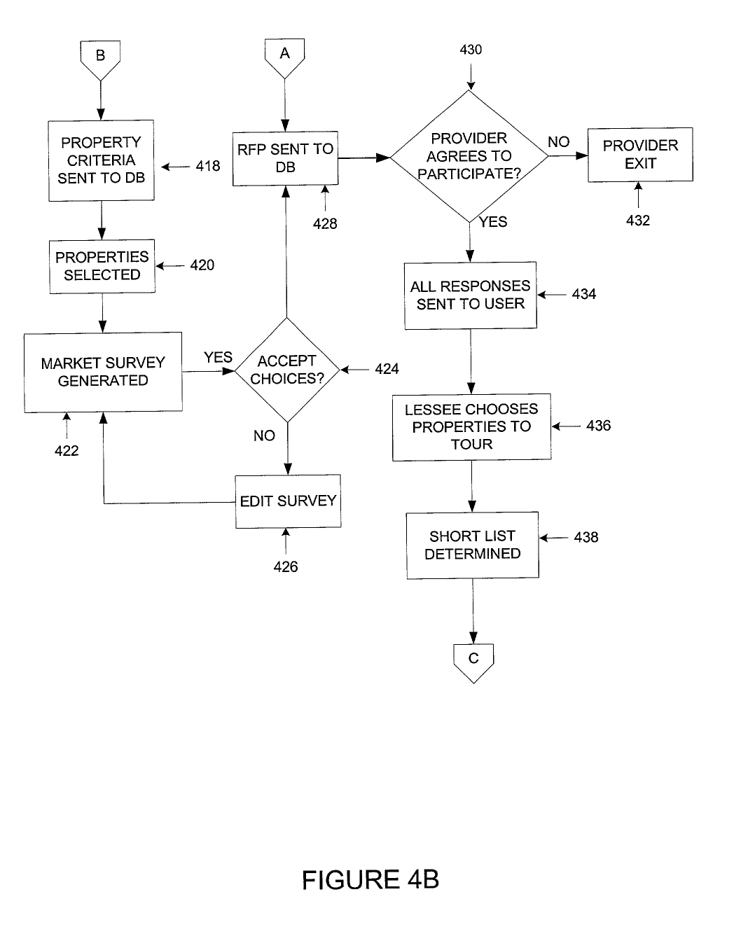

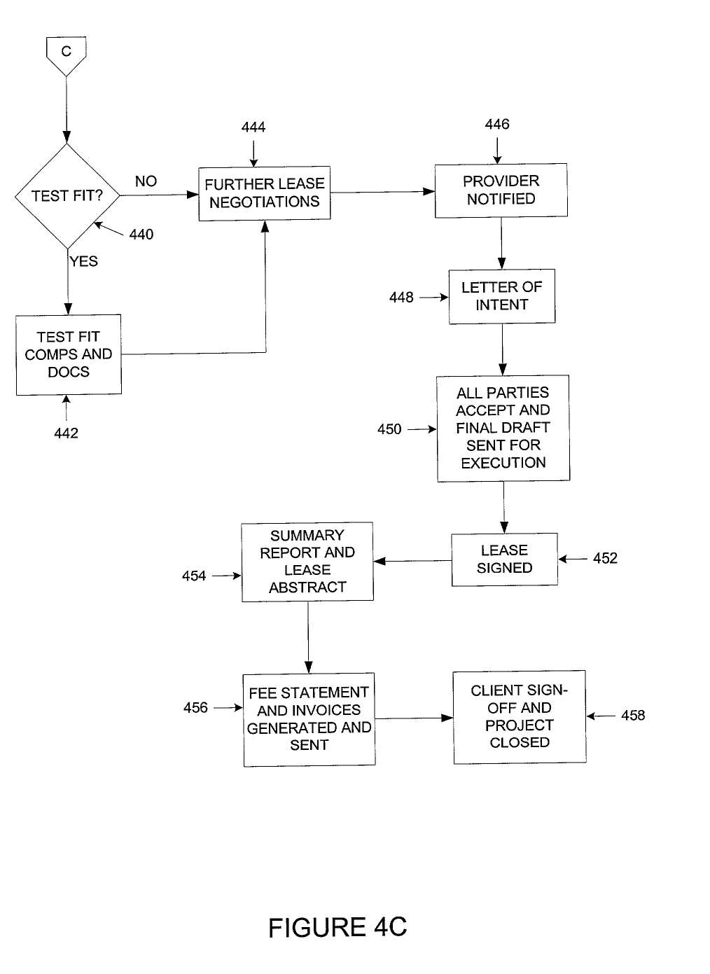

FIGS. 4A-4C illustrate a high-level flow diagram of a method for automating property leasing procedures according to an embodiment of the present invention. FIG. 3 should be referred to concurrently with the flow diagram illustrated in FIGS. 4A-4C. LeaseBoard™ 101 includes a system databases 107, 108 and 109 that may be stored in a single storage system and location. Further, system databases 107, 108 and 109, for reasons of security and convenience, may have linked portions stored in multiple locations and storage devices that are remote from the software that operates system databases 107, 108 and 109. Storage for system databases 107, 108 and 109 and LeaseBoard™ 101 may be any storage medium including hard disk drives, solid state disks, RAM memory, CD-ROM disks, etc., or any similar computer readable storage medium.

General user data is input in process step 402. The user input data is utilized throughout the entire leasing cycle process by user, broker and provider. Financial statements or a Dun and Bradstreet™ identification number are input to determine whether the user is a qualified leasing prospect. The normal practice is to provide “financials” much later in the process, usually when the user has agreed to lease a space. (process step 402). An initial requirement is the space that is required and a decision is made whether the user already knows the amount of space needed or the user needs assistance. (decision step 404). If the space needs are known, the user inputs his or her space needs (process step 410) to LeaseBoard™ 101. If the space needs are not fully known (e.g., a growing firm that may be continuously expanding) the user may access a space-planning program that is integral to LeaseBoard™ 101. (process step 406). The user, prompted by the space planning program, answers a variety of questions and selects the answers that best fit the user's desired needs. The space-planning program can be relatively simple, or it may be as complex as a detailed strategic workspace plan that projects space needs into the future and all the design steps can be monitored or preformed by a design specialist.

After all the questions are answered and the design needs are input, a space layout is provided by LeaseBoard™ 101 and presented to the user for approval. (process step 408). The space layout is directly interfaced with and automatically input into LeaseBoard™ 101. Actual design and construction of the premises may be set up to be managed or contracted through LeaseBoard™ 101 when the leasing process is complete. (process step 410).

A Strategic Needs Document will be generated by the system after receiving the necessary input from the user that, besides the amount of floor space, includes property types (e.g., class A building), locale (downtown, suburbs) and amenities (parking, etc.). The Strategic Needs Document (SND) is then generated which details the user's requirements and needs from both a real estate and operational perspective. The user reviews and modifies the SND as necessary. If the user is utilizing LeaseBoard™ 101 for a direct transaction, an electronic Letter of Engagement (LOE) is generated to formalize the legal relationship between the user and the LeaseBoard™ 101 operator. (process step 412).

The SND and either the space planning result (see process step 408) or the identified square foot requirements (see process step 410) then become the basis for creating a Request For Proposal (RFP). After a second and final review of the SND the user accepts and presents the document to LeaseBoard™ for processing. LeaseBoard™ 101 generates the RFP based on the SND and space requirements together. (process step 414).

The user is required by LeaseBoard™ 101 to determine whether or not a market survey is desired. (decision step 416). If the user determines that there is no need for a market survey, the RFP is then submitted to all landlords that meet the criteria outlined in the SND. (process step 428 in FIG. 4B). This action creates a “Market Bid” and providers are selected based upon a database query with the property database 108. The database query retrieves all the relevant properties in property database 108 that match the certain space needs of the user. The process then proceeds to decision step 430.

However, if a determination is made that a market survey is necessary, the specific property requirements are sent to property database 108. (process step 418 in FIG. 4B.) Properties from all providers that fit the requirements that are current in the property database 108 are then presented to the user. (process step 420). A market survey is generated that includes all selected properties (process step 422). Based on the accumulated information, the user then reviews the returned properties and selects the providers for which a RFP is to be sent.

If the user accepts any of the presented choices, the selected properties are used to submit RFPs to the respective providers and are posted to a secure area in transaction database 107 (process step 428) RFP's can also be sent to providers directly via interfaces 312, 316 and 320 as described in FIG. 3. Email notifications that an RFP has been posted are sent to the affected providers and/or their leasing agents and representatives. The providers then log in to the secure area in LeaseBoard™ 101. In order for the provider to proceed, in the case of a direct user transaction, the provider must commit to an agreed to fee paid to Leaseboard™ 101 if a lease is executed through the use of LeaseBoard™ 101 services (process step 430). Standard fee agreements and documents can be pre-negotiated with most large providers and remain in the system. If the provider decides not to pay a fee, or for any reason decides not to continue to negotiate for the subject property, the provider exits the process (process step 432).

If the provider accepts the RFP the provider responds to the RFP electronically trough the LeaseBoard™ 101 system. The RFP includes absolute, deal breaker requirements such as floor space, location, lease rate or like others. The RFP also includes the user's wishes and wants. The provider has to respond to all of the absolute requirements, but the provider may respond to the user's wishes and wants. LeaseBoard™ 101 and transaction database 107 manages the RFP provider responses including deadline management. A “best and final offer” is required of the provider or leasing agent in the first reply to the RFP. This eliminates the two or three conversations with the property representative to get to a “bottom-line” offer.

Upon receipt of the response proposals, LeaseBoard™ 101 will generate a summary report that compares the economics proposed by each property provider as well as other critical issues such as location of the space, signage, demographics, etc. A summary of all responses is then sent to the user (process step 434). The user then utilizes the responses and a summary report provided by LeaseBoard™ 101 to determine the office properties that will be physically inspected (process step 436). Decline letters are automatically generated by LeaseBoard™ 101 and sent to the providers whose properties were eliminated by the user. Notifications are also automatically sent to the property representatives whose properties have been selected for the tour.

After the building tours are complete, a final short list of potential properties is selected for final evaluation and negotiation. Based upon the short list, decline letters are automatically sent to the appropriate providers. (process step 438).

Referring to FIG. 4C, the user is given a choice of whether to “test fit” each space on the short list to determine whether the space will work for the user's space requirements (at least, new paint or carpet) or will there have to be some substantial changes. (decision step 440). If the user decides that some changes will have to be made, beyond cosmetic changes, to make a particular space workable, the user may access design interface 332 and construction interface 334 (represented in FIG. 3) which are integral applications and connect to partners with LeaseBoard™ 101. Partner interfaces provide convenient and efficient access to service providers that have already been approved by the property provider as members of LeaseBoard™. The partner interfaces provide communication between the user (or potential user) provider (landlord) and any service that will be needed to make the space chosen acceptable to all parties. Computer Aided Design (CAD) files of all the provider properties are made available on property database 108.

The test fit process is managed using time and date stamps so that each party, user and provider, is aware of the progress of a project. LeaseBoard™ 101 provides estimating tools that are accessible by all parties, including contractors and subcontractors, through the partners' interface. Further, cost estimates may be electronically posted by subcontractors. The test fit process quickly determines whether or not the potential lease space is adequate and operationally acceptable. Also, a construction estimate of user improvement costs for each space is available to both parties to include in negotiations (process step 442). The test fit results for each space requested is provided to the user and hard copy documents are provided (process step 442).

All relevant documents, including the test fit and construction estimates, are included with the final choice of properties. All the pertinent information accumulated from both parties is stored in the transaction database 107, including all the electronic communications and negotiations between the user, provider and all other participants involved in the lease engagement. Further lease negotiations may take place, at this point with the near-final choices (process step 444). The user then selects a preferred property and LeaseBoard™ 101 sends a notification to the winning provider. (process step 446). LeaseBoard™ 101 also provides a list of form Letters of Intent (LOI) that are available to the user. The Letter of Intent may be generated from a connected forms and documents database that contains all necessary documents, letters, etc., including legal documents necessary to begin and complete the leasing process. The user can modify any form LOI that is suitable to the user's taste. The stored letters of intent of the present invention are abbreviated in comparison to customary letters of intent. The core user (user) issues were identified and agreed to in the initial proposal phase thus, eliminating the need to restate them in the letter of intent. (process step 448)

The lease documentation process, including the electronic and documented legal negotiations, is managed by LeaseBoard™ 101 and the collaboration database 109. Collaboration, with time and date stamps provided for each party as well as lease execution and post execution processes, are itemized for both parties. The original lease document is either already contained within or posted to the collaboration database 109 by the provider. Provider, user, broker, attorney and all other parties involved in the lease documentation process collaborate online via LeaseBoard™ 101 and the collaboration database 109. Upon acceptance of the lease terms by all parties, copies of the lease are drafted and forwarded for execution by all parties (process step 450). Electronic and hard copy leases are provided for both parties. Formal signatures for the hard copy leases are made and the copies are sent to all parties. In the case of electronic copies, digital signatures are applied and all the copies are forwarded to the proper parties. An electronic copy of the lease is securely stored in the collaboration database 109 (process step 452).

In the case of the provider, the provider's in-house management system is automatically updated with regards to the newly leased unit within the property through the interface by LeaseBoard™ 101, upon approval by the provider. The user and provider receive both an electronic copy and a hard copy of the lease abstract and lease administration [renewal, expansion options, termination options, etc.] (process step 454).

After the lease document, electronic copy, hard copy or both, has been signed by both parties and the summary has been sent to the user, fee statements and invoices are generated by LeaseBoard™ 101 and sent to the provider (landlord) (process step 456). The user signs off on completion of the process and the LeaseBoard™ 101 project is closed and all pertinent data and information is stored in transaction database 107 (process step 458).

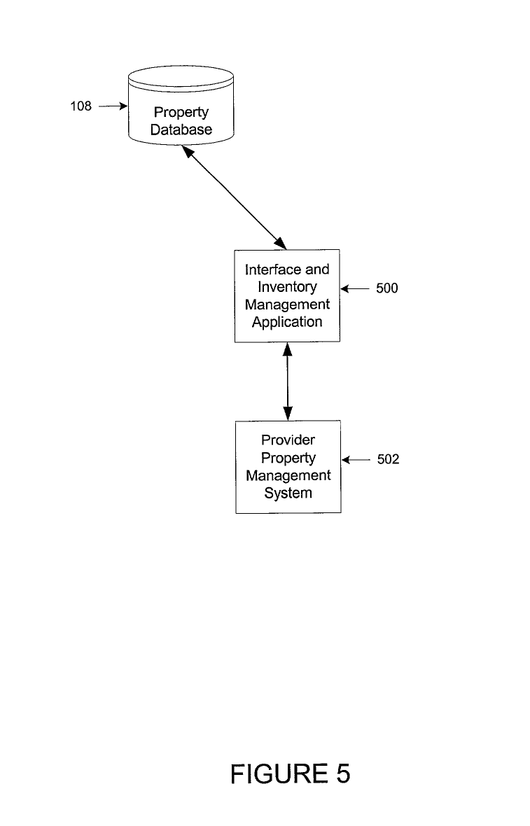

FIG. 5 illustrates a high-level block diagram of interface 500 according to an embodiment of the present invention. Interface 500 is coupled to an inventory management application and is operable to manage data regarding space and space availability in provider's property management system 502. Generally, property management system 502 may be a commercial software program for operation on a provider's computer system to manage property, as previously discussed. Data, concerning the provider's spaces within the properties monitored by property management system 502 is input at regular intervals such as weekly, monthly, quarterly, etc.

Interface 500 can be a software application that is integrated into a provider's property management system. Interface 500 may also be a standalone application incorporated into hardware that connects and communicates directly with property management system 502. Further, interface 500 can be a software application that installs on a provider's computer system and co-operates with property management system 502.

Interface 500 retrieves and manipulates up-to-date and time sensitive information from data stored in property management system 502. Specific and targeted data and information is retrieved by interface 500 based on business rules. Triggers are set within property management system 502 based on business rules set up by the provider. The business rules are centered on lease expiration, timing, credit, potential tenant, size of the space, etc. These business rules provide criteria that determine when a particular space will be shown as available for lease to property database 108. Interface 500 regularly queries the property management system 502 and when the criteria of the rules are met, interface 500 automatically signals the provider and displays space posting data for the provider. The provider checks the property spaces presented and determines if there are spaces that should not be posted. After the provider approves the spaces, interface 500 posts all newly available spaces to property database 108. As the space data changes in property database 108, interface 500 updates property management system 502 so that both sources of space data are current and accurate. All of the fore mentioned processes can be fully automated without provider interaction if the provider so chooses.

Further, interface 500 provides true space inventory management. Interface 500 can retrieve many data fields that are of no use to property management system 502. As pointed out previously, most property management systems are primarily focused on the financial aspects of the property. The data available through interface 500 enables the provider to also generate time sensitive available inventory reports on the spaces in the properties under management.

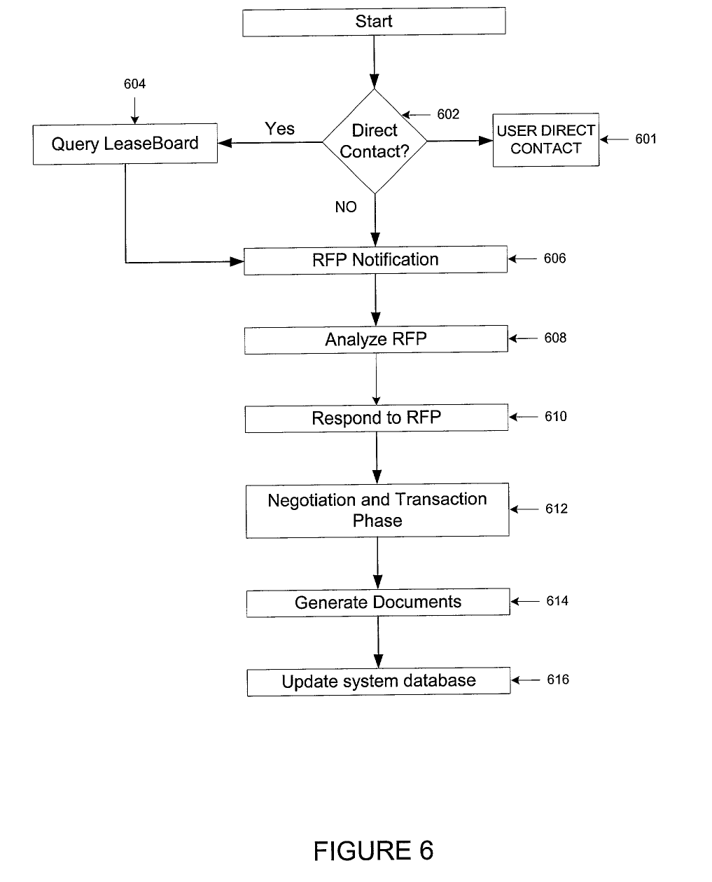

FIG. 6 is a high-level flow diagram of a method for automating property leasing procedures for providers according to an embodiment of the present invention. The providers-side leasing cycle begins traditionally, with a user either contacting a provider directly (process step 601), or through LeaseBoard™ 101 (process step 604). If the user makes a traditional direct contact, the provider may utilize LeaseBoard™ 101 and the available tools and data to manage the provider's leasing process. If the user contact is made through LeaseBoard™ 101, the leasing cycle begins with notification to a provider of a request for proposal from a LeaseBoard™ 101 user (process step 606).

From the provider's perspective, notification is received from LeaseBoard™ 101 that a user has posted an RFP for a provider property. This is based on information obtained by the user from the property database 108. The RFP is stored in a secure area of transaction database 107 and notification is sent to the affected providers that the RFP is now available for review. (process step 606)

At this point the provider has also been sent certain criteria on the user by LeaseBoard™ 101, such as space requirements, timing, financial information, etc. (The entry of user data and qualifications were discussed in the flow diagram of FIG. 4) The provider decides whether to participate in the lease process reviewing the user's RFP and financial criteria. If the provider decides to participate, the RFP is electronically transmitted to the providers transaction management system via the LeaseBoard™ interface. The provider then reviews the RFP within the LeaseBoard™ system. The provider may also capture the user data, with the RFP that was initially entered which provides a better picture of the prospective user.

A core proposal is generated by the provider, or his agent, based on the user's wants, needs and space criteria. The provider's proposal may be generated from the LeaseBoard™ system utilizing a resident proposal clause library that is available for keyword or subject search. Once the initial proposal draft is produced the provider may subject the proposal to a “what if” financial analysis that is available from LeaseBoard™ through the interface (process step 608). Budget information available from the provider's property management system may be used to determine the value of the proposal to the provider. By subjecting the proposal to a financial analysis prior to negotiations, certain variables may be adjusted to arrive at an optimal proposal, further compressing transaction cycle time (process step 608). The final, adjusted proposal is then submitted through LeaseBoard™ to the user. The proposal is then stored in LeaseBoard™ 101. (process step 610).

LeaseBoard™ 101 manages all RFP and provider proposals. Once the tenant reviews the proposals and a short list is determined, notifications are sent to the providers and property tours are scheduled.

After the property tours are complete, the providers are notified of the results and given feedback from the tours. As discussed previously, LeaseBoard™ 101 provides design and construction software, and partners, for both users and providers. The design and construction modules help determine that the space is operationally acceptable and construction cost estimates can be determined to confirm that the improvement costs are within the proposal to the user. (process step 612).

After the user decides on a final property, a Letter of Intent is sent to the winning provider. The provider may provide an electronic copy of the provider's choosing or select and modify stored lease versions in the LeaseBoard™ lease library. Once the initial lease draft is approved and accepted by the provider, it is submitted to the LeaseBoard™ secure document and collaboration database 109. This server is part of the LeaseBoard™ 101 system and is connected to the transaction database 107. The user and provider (or their representatives) communicate via the collaboration server and all activities are tracked with time and date stamps.

Upon acceptance by all parties, copies of the lease are then printed and forwarded for execution—both electronically and a hard copy with a formal signature. Upon execution, an invoice for LeaseBoard™'s services is generated and sent to the provider or the provider's agent. (process step 614).

Once a final lease is approved and executed, LeaseBoard™ will produce a lease abstract that will be routed to the appropriate provider parties for approval and review. The data from the executed lease is updated to the providers property management system. That is, the space description and all the necessary space information is updated in the provider's system by LeaseBoard™ through the interface. Additionally, LeaseBoard™ will remove the space from the list of available inventory on LeaseBoard™'s system database. User billing then commences as per the terms of the lease. (process step 616).

The above-described embodiments of the present invention are directed towards leasing an office property. However, virtually any property leasing field may be adapted to utilize the principles and methods set forth herein. The present invention may be used specifically in leasing other commercial property types such as retail, industrial and/or multi-family. Other properties may include but are not limited to transportation property, radio and television transmission towers, industrial property or any other property that may be leased and that involves a property provider and a property user.

Although the present invention has been described in detail, those skilled in the art should understand that they can make various changes, substitutions and alterations herein without departing from the spirit and scope of the invention in its broadest form.

What is claimed is:

1. An automated property leasing system, comprising:
a property database for storing data of property providers and property users, wherein at least one property provider and at least one property user are connected to said database via said network;
an interface coupled to said property database and coupled to an in-house property management system of said at least one property provider, said interface capable of extracting targeted data from said in-house property management system and capable of modifying said targeted data in said in-house property management system; and
a transaction management application comprising one or more computer executable modules, said transaction management application coupled to said property database and coupled to said network and capable of automating a leasing cycle between said property provider and said property user.

2. The automated property leasing system as set forth in claim 1 wherein said transaction management application is capable of implementing all transactions necessary to the initiating, negotiating and completion steps to execute a lease document within said leasing cycle.

3. The automated property leasing system as set forth in claim 1, wherein said interface further comprises:
an interface application for extracting the contents of targeted fields in the provider's in-house property management system, wherein said interface application is capable of formatting the extracted data for display;
responsive to a command from an authorized in-house property management system operator, said interface is capable of sending said extracted contents to said property database via said network; and
responsive to a completed leasing cycle, said interface application is capable of updating said property database and said in-house property management system.

4. The automated property leasing system as set forth in claim 1 wherein said property information further comprises:
physical details of each available property;
photographic and video images of said available property;
demographic data of the neighborhood surrounding said available property;
traffic data in the neighborhood surrounding said available property; and
leasing terms of said available property.

5. The automated property leasing system as set forth in claim 1 further comprising:
a module for generating all necessary documents to initiate, negotiate and complete said leasing cycle
a module for generating all correspondence necessary to initiate, negotiate and complete said leasing cycle.

6. The automated property leasing system as set forth in claim 1 further comprising a module for designing and determining whether a selected space will fit the parameters of the user.

7. The automated property leasing system as set forth in claim 1 further comprising:
a transaction database for storing transactions between said property user, said property provider and at least one broker; and
a collaboration database for storing communications between said property users, said property provider and said at least one broker.

8. An automated real estate property leasing system for use in a network, comprising:
a property database for storing data of property providers and property users, wherein at least one property provider and at least one property user are connected to said database via said network;
an interface coupled to said property database and coupled to an in-house property management system of said at least one property provider, said interface capable of extracting targeted data from said in-house property management system and capable of modifying said targeted data in said in-house property management system; and
a transaction management application comprising one or more computer executable modules, said transaction management application coupled to said property database and coupled to said network and capable of automating a leasing cycle between said property provider and said property user.

9. The automated real estate property leasing for use in a network as set forth in claim 8 wherein said transaction management application is capable of implementing all transactions necessary to the initiating, negotiating and completion steps to execute a lease document within said leasing cycle.

10. The automated real estate property leasing system for use in a network system as set forth in claim 8 wherein said property information further comprises:
physical details of each available property;
photographic and video images of said available property;
demographic data of the neighborhood surrounding said available property;
traffic data in the neighborhood surrounding said available property; and
leasing terms of said available property.

11. The system for associating real estate owners and real estate users procedures as set forth in claim 8, wherein said interface further comprises:
an interface application for extracting the contents of targeted fields in the provider's in-house property management system, wherein said interface application is capable of formatting the extracted data for display;
responsive to a command from an authorized in-house property management system operator, said interface is capable of sending said extracted contents to said property database via said network; and
responsive to a completed leasing cycle, said interface application is capable of updating said property database and said in-house property management system.

12. The automated real estate property leasing system as set forth in claim 8 further comprising:
a module for generating all necessary documents to initiate, negotiate and complete said leasing cycle
a module for generating all correspondence necessary to initiate, negotiate and complete said leasing cycle.

13. The system for associating real estate owners and real estate users as set forth in claim 1 further comprising a module for designing and determining whether a selected space will fit the parameters of the user.

14. The system for associating real estate owners and real estate users as set forth in claim 1 further comprising:
a transaction database for storing transactions between said property user, said property provider and at least one broker; and
a collaboration database for storing communications between said property user, said property provider and said at least one broker a module for generating all correspondence necessary to initiate, negotiate and complete a lease cycle.

15. A method for automating a property leasing system, comprising the steps of:
storing lease information data, of property providers and property users, in a property database wherein said property providers and said users are connected to said property database via said network;
extracting targeted data from an in-house property management system utilizing an interface coupled to said property database and couplet to at least one said property provider's in-house property management system; and
utilizing a transaction management application comprising one or more computer executable modules, said transaction management application is coupled to said property database wherein said transaction management application is capable of automating a leasing cycle between said at least one property provider and at least one property user.

16. The method for automating a property leasing system as set forth in claim 15 wherein said transaction management application is capable of providing all transactions necessary to the initiating, negotiating and completion steps to execute a lease document within said leasing cycle.

17. The method for automating a property leasing system as set forth in claim 15 wherein said property information further comprises:
physical details of each available property;
photographic and video images of said available property;
demographic data of the neighborhood surrounding said available property
traffic data in the neighborhood surrounding said available property; and
leasing terms of said available property.

18. The method for automating said property leasing system as set forth in claim 15, wherein said interface further comprises:
extracting targeted data in said at least one provider's in-house property management system, utilizing an interface application capable of formatting said extracted data for display; and
sending said extracted data to said property database via said network; and
updating said property database and said in-house property management system.

19. The method for automating said property leasing system as set forth in claim 15 further comprising generating all necessary documents and correspondence for initiating, negotiating and completing the leasing cycle.

20. The method for automating said property leasing as set forth in claim 15 further comprising:
storing transactions between said property user, said property provider and a broker in a broker in a transaction database; and
storing communications between said property user, said property provider and said broker in a collaboration database.
